(19) United States
(12) Patent Application Publication
(10) Pub. No.: US 2024/0289624 A1
(43) Pub. Date: Aug. 29, 2024

(54) NEURAL NETWORK DEVICE HAVING STRUCTURE FOR HANDLING DIFFERENT OUTPUT COMBINATIONS AND OUTPUT HANDLING METHOD THEREOF

(71) Applicant: UIF (University Industry Foundation), Yonsei University, Seoul (KR)

(72) Inventor: Chul Hee LEE, Goyang-si (KR)

(21) Appl. No.: 18/392,527

(22) Filed: Dec. 21, 2023

(30) Foreign Application Priority Data
Feb. 27, 2023 (KR) 10-2023-0025574

(51) Int. Cl. G06N 3/084; G06N 3/04

(52) U.S. Cl. CPC G06N 3/084; G06N 3/04

(57) ABSTRACT

The disclosed embodiment provides a neural network device and an output handling method thereof, that selects at least one class combination of different numbers and types from N (where N is a natural number) classes designated for input data, sets, according to each class combination selected in a neural network module including a plurality of layers, at least one layer among the layers of the neural network module as a changeable variable layer, and outputs a result of performing a neural network operation on the input data by changing the variable layer set according to the selected class combination, and a weight of the variable layer. The neural network device and output handling method thereof adaptively determines the number and type of classes to be identified by varying them in various combinations depending on the usage situation, and identifies classes according to the determined class combination.

### CROSS-REFERENCE TO RELATED APPLICATIONS

This application claims priority under 35 U.S.C. § 119(a) to Korean Patent Application No. 10-2023-0025574, filed on Feb. 27, 2023, with the Korean Intellectual Property Office, the disclosure of which is incorporated herein in its entirety by reference.

### BACKGROUND

### 1. Technical Field

The disclosed embodiments relate to a neural network device and an output handling method thereof, and more particularly to a neural network device having a structure for handling different output combinations and an output handling method thereof.

### 2. Description of the Related Art

With the advancement of technology, artificial neural networks are currently being used for a variety of purposes in a very wide range of fields, and accordingly, the types of neural networks are also becoming more diverse.

In the case of a neural network, the operations or performance that can be performed during subsequent use are basically determined by the learning performed in advance. In addition, the operations or performance determined by learning rarely changes unless additional learning or the like is performed, and even if additional learning is performed, in most cases, the performance does not represent the required performance.

Therefore, the initial learning performed in neural networks is very important, and currently, most neural networks are trained to have as much versatility as possible in the fields in which they are used. In other words, neural networks are trained so that they can distinguish all classes that require identification in the field of use during initial learning. For example, in the case of neural networks used in self-driving vehicles, they are trained to identify not only roads, vehicles, and pedestrians, but also numerous objects that the vehicle can detect while driving, such as streetlights, buildings, various animals, or plants, by classifying them into different classes.

Considering this learning method of neural networks, current learning data provides a large number of distinguishable classes so that each neural network can be versatile in the field in which it is used when trained. As an example, ImageNet, one of the representative neural network learning data, provides approximately 1000 classes to identify objects included in images.

However, increasing the number of classes that a neural network can identify does not necessarily improve the performance of the neural network. This is because the performance of a neural network is determined not only by its versatility based on the number of classes that can be identified, but also by the accuracy of the identified classes. For example, even if a neural network was trained to identify 100 classes, if the identification accuracy is significantly lower than that of a neural network trained to identify 50 classes, the performance of the neural network may be said to have deteriorated. And in reality, if increasing the number of classes that can be identified when learning a neural network, the identification accuracy tends to decrease in most cases. Therefore, it is very difficult to increase both the number of classes that a neural network can identify and the identification accuracy. In other words, there are limits to improving the performance of neural networks.

### SUMMARY OF THE INVENTION

An object of the disclosed embodiments is to provide a neural network device and an output handling method thereof that can dramatically improve the performance of a neural network by varying the number and type of classes to be identified by the neural network in various combinations.

A further object of the disclosed embodiments is to provide a neural network device and an output handling method thereof that can significantly improve identification accuracy by adaptively determining a combination of different classes according to the use situation of the neural network.

Another object of the disclosed embodiments is to provide a neural network device and an output handling method thereof that can obtain an effect similar to having a large number of neural networks with a small storage capacity and selectively using a neural network suitable for the usage situation, by varying the weights and inputs of some layers of the neural network.

A neural network according to an embodiment comprises: one or more processors; and a memory storing one or more program executed by the one or more processors, wherein the processors select at least one class combination of different numbers and types from N (where N is a natural number) classes designated for input data, set, according to each class combination selected in a neural network module including a plurality of layers, at least one layer among the layers of the neural network module as a changeable variable layer, and output a result of performing a neural network operation on the input data by changing the variable layer set according to the selected class combination, and a weight of the variable layer.

The processors may pre-designate and store variable layers and weights whose weights will be changed according to each class combination, and change the weights of the designated variable layers to the stored weights according to the selected class combination.

The processors may output a likelihood for each class in the number of variable layers corresponding to the number of classes included in each class combination.

The processors may set the final FC layer of the neural network module configured to output a likelihood for each of the N classes as the variable layer, and change the structures and weights of the variable layers to output a likelihood for a number of classes smaller than N according to the class combination.

The processors may set, as the variable layer, an adaptive decision layer additionally arranged to receive an output of the final FC layer of the neural network module configured to output a likelihood for each of the N classes, and change the structures and weights of the variable layers to output a likelihood for a number of classes smaller than N according to the class combination.

The processors may select at least one feature extraction layer according to the class combination among a plurality of feature extraction layers that receive the input data or the output of the previous layer from the neural network module and perform a neural network operation to estimate and output features and set it as a selection feature extraction layer, and concatenate the output of the selection feature extraction layer with the input of the set variable layer and apply them together.

The processors may concatenate some outputs designated among the outputs of the selection feature extraction layer with the input of the variable layer according to the class combination.

The processors may add, to the neural network module, a sub-feature extraction layer, configured separately from a plurality of feature extraction layers that receives the input data or the output of the previous layer according to the class combination and performs a neural network operation to estimate and output features, and extracting features by receiving the output of one feature extraction layer of the plurality of feature extraction layers, and concatenate the input of the set variable layer with the output of the sub-feature extraction layer and apply them together.

The sub-feature extraction layer may be configured so that the output is not transmitted to other layers of the neural network module.

The processors may select the class combination based on at least one of an external situation according to an environment in which the neural network device is used or an internal situation according to an output of the neural network module.

The processors may perform learning based on learning data for the N classes to determine a weight of each layer provided in the neural network module, and then perform additional learning based on learning data including classes according to at least one class combination among the learning data, thereby determining the variable layer set according to each class combination and the weight changed in the variable layer.

An output handling method of a neural network according to an embodiment, performed by a computing device having one or more processors and a memory that stores one or more programs to be executed by the one or more processors, comprises the steps of: selecting at least one class combination of different numbers and types from N (where N is a natural number) classes designated for input data; setting, according to each class combination selected in a neural network module including a plurality of layers, at least one layer among the layers of the neural network module as a changeable variable layer; and outputting a result of performing a neural network operation on the input data by changing a weight of the variable layer set according to the selected class combination to a preset and stored weight.

Accordingly, the neural network device and output handling method thereof of the embodiment adaptively determines the number and type of classes to be identified by varying them in various combinations depending on the usage situation of the neural network, and identifies classes according to the determined class combination, so that classes requiring identification in the current situation can be accurately identified. Therefore, the performance of neural networks can be dramatically improved. In addition, by applying a method of varying the weights and input values of some layers in response to each class combination, it is possible to provide a neural network with performance similar to that of having a large number of neural networks with a very small storage capacity and selectively using neural networks appropriate for the usage situation.

### BRIEF DESCRIPTION OF THE DRAWINGS

FIG. 1 shows a schematic structure of a neural network device.

FIG. 2 shows a schematic structure of a neural network device according to an embodiment.

FIG. 3 shows a schematic structure of a neural network device according to another embodiment.

FIGS. 4 and 5 show schematic structures of a neural network device according to still other embodiments.

FIG. 6 shows an output handling method of a neural network device according to an embodiment.

FIG. 7 is a diagram for explaining a computing environment including a computing device according to an embodiment.

### DETAILED DESCRIPTION OF THE INVENTION

Hereinafter, specific embodiments of an embodiment will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments, and should not be construed as limitative. Unless the context clearly indicates otherwise, the singular forms are intended to include the plural forms as well. It should be understood that the terms “comprises,” “comprising,” “includes,” and “including,” when used herein, specify the presence of stated features, numerals, steps, operations, elements, or combinations thereof, but do not preclude the presence or addition of one or more other features, numerals, steps, operations, elements, or combinations thereof. Also, terms such as “unit”, “device”, “module”, “block”, and the like described in the specification refer to units for processing at least one function or operation, which may be implemented by hardware, software, or a combination of hardware and software.

Here, before explaining a variable neural network device according to the embodiment, a structure of a general neural network device is first described to facilitate understanding.

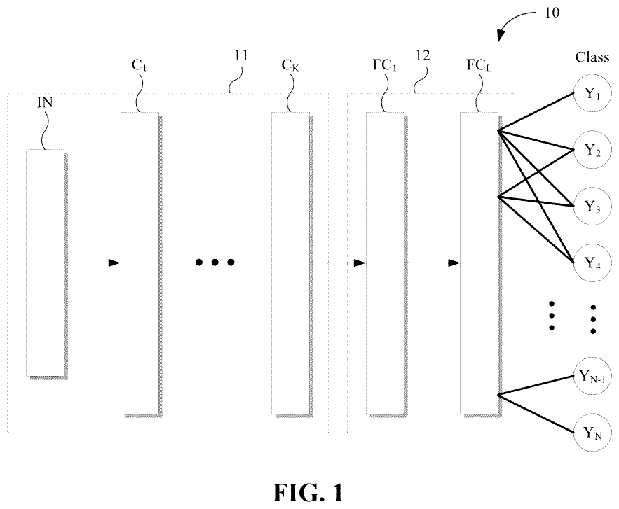

FIG. 1 shows a schematic structure of a neural network device.

FIG. 1 shows a structure of the most common neural network among various neural networks as an example. As shown in FIG. 1, the neural network module 10 may include a feature extraction unit 11 and a class classification unit 12. The feature extraction unit 11 receives input data and performs a neural network operation to extract features of the input data, and the class classification unit 12 receives the features extracted from the feature extraction unit 11 and performs a neural network operation to estimate a likelihood indicating the level of possibility for each of the multiple classes for which the input data is designated.

The feature extraction unit 11 may be configured to include an input layer IN and a plurality of feature extraction layers C₁ to C_{K}. The input layer IN receives input data, and each of the plurality of feature extraction layers C₁ to C_{K} receives the output of the previous layer IN, C₁ to C_{K-1}, performs a neural network operation to extract features, and transmits them to the next layer.

Here, the reason why the feature extraction unit 11 has a plurality of layers IN, C₁ to C_{K} to repeatedly extract features is to enable more accurate feature extraction, and the number of layers provided in the feature extraction unit 11 may be adjusted in various ways.

Each of the plurality of layers IN, C₁ to C_{K} of the feature extraction unit 11 has a weight previously acquired through learning, and performs a neural network operation on the input value using a specified method between the acquired weight and the input value. In this case, each layer IN, C₁ to C_{K} of the feature extraction unit 11 may be implemented as a convolution layer that performs a convolution operation, a representative neural network operation, but is not limited to this. Here, the input layer IN can also be viewed as a feature extraction layer.

The class classification unit 12 may include at least one fully connected (FC) layer. Here, it is assumed that the class classification unit 12 includes L FC layers FC₁ to FC_{L}, and the likelihood Y₁ to Y_{N} for each class are output with a linear sum of the final FC layers FC_{L}. Here, the likelihood for each class can also be calculated with a function of the final FC layer FC_{L}. That is, the final FC layer FC_{L} consists of a final vector for outputting likelihoods for all types of classes that the neural network must identify, and in FIG. 1, it is configured to output a likelihood Y₁ to Y_{N} for each of N classes. The class likelihoods Y₁ to Y_{N} can be calculated according to a linear sum as in Equation 1.

$${Y}_{j} = {W}_{j} \cdot {FC}_{L} = {\sum }_{k} {w}_{j}^{k} {FC}_{L}^{k} = {w}_{j}^{0} {FC}_{j}^{0} + {w}_{j}^{1} {FC}_{j}^{1} + … \qquad [ Equation 1 ]$$

where, Yⱼ represents the likelihood of the jth class, wⱼ represents a likelihood weight vector of the jth class, and FC_{L} represents a final layer vector.

The FC layers FC₁ to FC_{L} of the class classification unit 12 also have weights previously acquired through learning, and perform neural network operations on input values using the acquired weights to output a likelihood for each class.

As described above, in the case of a typical neural network, it is trained to output likelihoods by distinguishing as many classes as possible that require identification in the field of use of the neural network. However, the identification accuracy of neural networks tends to decrease as the number of classes to be identified increases. However, in reality, in actual neural network operation situations, there are rarely cases where a large number of classes to be identified exist at the same time. In most cases, the number of important recognition target classes that must be simultaneously identified in input data when operating a neural network is less than 5. In other words, in many cases, it is sufficient for a neural network to be able to identify only about 5 classes. However, since the number or type of classes to be identified frequently changes depending on the situation, the class classification unit 12 outputted likelihoods Y₁ to Y_{N} for all identifiable classes, not just the classes appropriate for each situation.

However, if a neural network can be flexibly configured to select combinations of various classes and output only the likelihoods for the classes of the selected class combinations, the various classes required can be identified very accurately by selecting an appropriate class combination depending on the situation. Accordingly, the embodiment proposes a variable neural network device that selects a class combination according to the situation, changes its configuration adaptively according to the selected combination, and handles different output combinations.

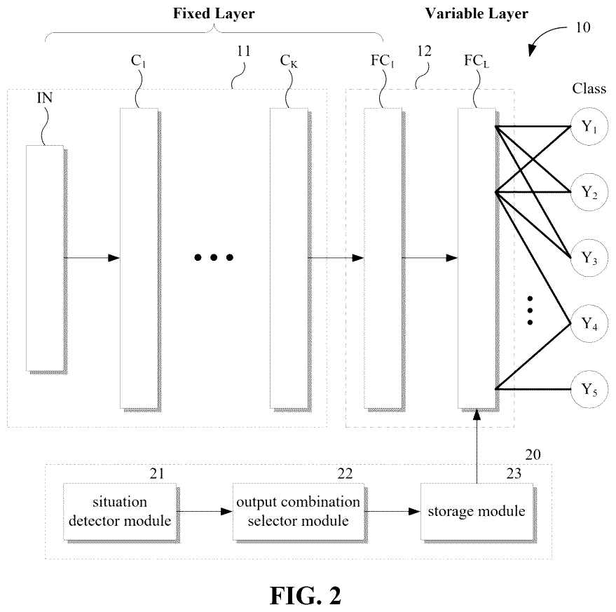

FIG. 2 shows a schematic structure of a neural network device according to an embodiment.

Referring to FIG. 2, a neural network device according to an embodiment may include a neural network module 10 and a situation adaptor module 20. Here, the neural network module 10 may be configured the same as the neural network module 10 of FIG. 1. That is, the neural network module 10 can be divided into a feature extraction unit 11 and a class classification unit 12, and the feature extraction unit 11 may include an input layer IN and a plurality of feature extraction layers C₁ to C_{K}, and the class classification unit 12 may include at least one FC layer FC₁ to FC_{L}. Here, the number or configuration of layers provided in each of the feature extraction unit 11 and the class classification unit 12 may be adjusted in various ways.

In FIG. 2, the feature extraction unit 11 and the class classification unit 12 can first be trained to identify N classes as before. That is, each layer of the feature extraction unit 11 and the class classification unit 12 is learned to identify N classes, and a weight for each layer is obtained. However, in the neural network device according to the embodiment, the neural network module 10 performs additional learning for each of various situational class combinations. In this case, the final FC layer FC_{L} of the class classification unit 12 and the likelihood weight vector used for likelihood calculation may be reconfigured to identify only the number of classes (here, 5 as an example) according to each class combination.

In many cases, each layer of the neural network is implemented in software, so the configuration of the final FC layer FC_{L} can also be easily reconfigured. In addition, even if the neural network is implemented in hardware, the number of classes finally identified can be configured to be variable by adding switches between the final FC layer FC_{L} and the class nodes Y₁ to Y_{N} representing each class likelihood.

In addition, while most layers among the multiple layers of the neural network module 10 are fixed so that the weights obtained in previous learning remain the same, only at least one final layer located last may obtain weights that are changed by learning.

In the case of FIG. 2, only the weight W_{L} of the final FC layer FC_{L} is set as a variable layer, and the configuration and weight are variable according to the class combination for each situation. In addition, it is assumed that all remaining layers IN, C₁ to C_{K}, FC₁ to FC_{L-1} are set as fixed layers and fixed so that their configuration and weights do not change. Here, as an example, it is assumed that only the final FC layer FC_{L} is set as a variable layer, but the number of layers set as a variable layer may also be changed. In addition, in FIG. 2, it is also possible to fix the final FC layer FC_{L} and set only the weights between the final FC layer FC_{L} and class nodes Y₁ to Y_{N} to vary.

Afterwards, learning is performed individually for each of the multiple situational class combinations, and the weight W_{L} of the variable layer according to each situation, here, the final FC layer FC_{L}, is obtained. In addition, the configuration of the final FC layer FC_{L} and the obtained weight W_{L} according to the class combination for each situation are stored in the storage module 23.

Meanwhile, after learning, the situation adaptor module 20 checks the current situation of the neural network device during actual operation, selects an appropriate class combination, and applies the stored configuration and weight of the variable layer to the neural network module 10 according to the selected class combination.

The situation adaptor module 20 may include a situation detector module 21, an output combination selector module 22, and a storage module 23. The situation detector module 21 detects, analyzes, and checks the current situation of the neural network device. The situation detector module 21 may include one or more components that can check the situation in which the neural network device is operating. In this case, the situation detector module 21 may be configured to detect at least one of external factors or internal factors of the neural network device.

For example, when a neural network device is applied to a vehicle, the situation detector module 21 may include various sensors for detecting the external situation of the neural network device, such as an illumination sensor for distinguishing between day and night, a GPS sensor for determining movement speed and location, and a temperature and humidity sensor. This is because the classes to be identified during the day and the classes to be identified at night may be different while the vehicle is moving, and the number and type of classes to be identified may be different on general roads and automobile-only roads such as highways. In addition, the situation detector module 21 may be configured to detect the situation from input data.

Additionally, the situation detector module 21 may be configured as an analysis module that detects internal factors according to the likelihood for each class in a previously selected class combination as a situation, regardless of external factors. In general, the neural network module 10 identifies the class with the highest possibility among likelihoods for each class output from the final FC layer FC_{L} as the class for the input data. However, if the number of classes to be identified is too large or an incorrect class combination is identified, likelihoods for many different classes may be obtained similarly, or likelihoods for the wrong class may be output higher, and in some cases, likelihoods for all classes may all be obtained below the threshold value. In other words, the class corresponding to the input data may not be accurately identified. Accordingly, the situation detector module 21 may be implemented as an analysis module that determines the need to change the class combination by analyzing the likelihood for each class in the previously selected class combination.

Here, each situation detected by the situation detector module 21 may be preset in a variety of ways.

The output combination selector module 22 selects an output combination suitable for the situation identified by the situation detector module 21, that is, a class combination. In this case, a situational class combination according to the situation detected by the situation detector module 21 may also be set and stored in advance. The output combination selector module 22 may be configured to select only one class combination for the identified situation, but may also be configured to select multiple class combinations.

The storage module 23 selects the configuration and weight of the stored variable layer according to the class combination selected in the output combination selector module 22. Then, the selected configuration and weight are applied to the designated variable layer (here, the final FC layer (FC_{L})), so that the configuration and weight of the variable layer are changed.

If the configuration and weight of the variable layer are changed according to the selected class combination, the changed variable layer acquires likelihoods only for a small number of classes suitable for the current situation of the neural network device, so it is possible to identify the class for the input data very accurately. In addition, since different class combinations are adaptively selected for various situations, classes suitable for various situations can be selected and identified.

In this case, as described above, the situation detector module 21 may not only determine the need to change the class combination by analyzing the likelihood for each class in the selected class combination, but also, when multiple class combinations are selected, determine the class with the highest likelihood among the likelihoods for classes acquired from the selected multiple class combinations as the identified class.

The neural network device may be configured to have a plurality of neural network modules corresponding to each class combination according to each situation. However, when the neural network device is equipped with a plurality of neural network modules, the configuration and weights of all layers (IN, C₁ to C_{K}, FC₁ to FC_{L}) must be stored, which not only requires a very large amount of storage space, but also results in a significant increase in the required amount of computation.

In the embodiment, in order to reduce this inefficiency, the neural network device selects a class combination appropriate for the situation, and changes the configuration and weight of some designated variable layers among the plurality of layers of the neural network module 10 according to the selected class combination to adaptively identify classes for each situation, greatly improving efficiency.

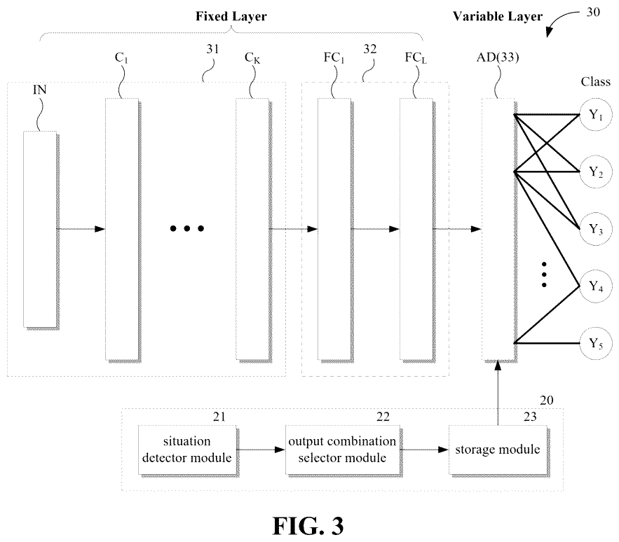

FIG. 3 shows a schematic structure of a neural network device according to another embodiment.

The neural network device of FIG. 3 also includes a neural network module 30 and a situation adaptor module 20, as in FIG. 2. In addition, in the neural network module 30, the feature extraction unit 31 and the class classification unit 32 may be configured in the same way as the feature extraction unit 11 and the class classification unit 12 of FIG. 2. However, in FIG. 2, at least one layer including the final FC layer FC_{L} of the class classification unit 12 is composed of a variable layer that varies according to the configuration and weights stored in the storage module 23, whereas in FIG. 3, all layers IN, C₁ to C_{K}, FC₁ to FC_{L} of the feature extraction unit 31 and the class classification unit 32 are composed of fixed layers that do not vary. Instead, the neural network module 30 of FIG. 3 further includes an adaptive decision layer AD (33) placed after the final FC layer FC_{L}.

In the neural network module 10 of FIG. 2, the configuration and weight of the final FC layer FC_{L} vary depending on the selected class combination, so the weights W_{L} required to calculate the final FC layer FC_{L} learned and acquired to identify all possible classes were not utilized to their full potential. Since the weights acquired by learning are fixed in the layers IN, C₁ to C_{K}, FC₁ to FC_{L-1} before the final FC layer FC_{L}, even if the final FC layer FC_{L} is changed, it can show excellent class identification performance for various class combinations, but the learning result of the final FC layer FC_{L} may not be sufficiently reflected.

Accordingly, in FIG. 3, the final FC layer FC_{L} includes the weights acquired by learning as is to identify all possible classes, and the configuration and weights of the added adaptive decision layer 33 are varied according to each class combination. Therefore, in FIG. 3, all layers of the feature extraction unit 31 and the class classification unit 32 are set as fixed layers, and only the adaptive decision layer 33 is set as a variable layer. Here, as a simple example, a case where the adaptive decision layer 33 is implemented as one layer is shown, but the adaptive decision layer 33 may also be implemented as a plurality of layers.

In addition, in FIG. 3, the situation adaptor module 20 may include a situation detector module 21, an output combination selector module 22, and a storage module 23, as in FIG. 2. In addition, the situation detector module 21 and the output combination selector module 22 operate in the same way as in FIG. 2. However, since the adaptive decision layer 33 is set as a variable layer, unlike in FIG. 2, the storage module 23 stores the configuration and weights of the adaptive decision layer 33 rather than the final FC layer FC_{L}, and applies the configuration and weights of the adaptive decision layer 33 according to the class combination selected in the output combination selector module 22 to the adaptive decision layer 33.

When learning, the neural network device in FIG. 3 first performs learning to identify all possible classes with the adaptive decision layer 33 excluded, and acquires weights for fixed layers, that is, all layers IN, C₁ to C_{K}, FC₁ to FC_{L} of the feature extraction unit 31 and the class classification unit 32. Afterwards, the adaptive decision layer 33 is set to have a configuration according to each of a plurality of class combinations and added to the neural network module 30, and using the learning data corresponding to each class combination, the weight of the added adaptive decision layer 33 is acquired. At this time, the weights of previously acquired layers IN, C₁ to C_{K}, FC₁ to FC_{L} are fixed and do not change. Once the structure and weights of the adaptive decision layer 33 for each class combination are determined, the determined structure of the adaptive decision layer 33 and the necessary weights are stored in the storage module 23.

In addition, during the test operation, the situation detector module 21 of the situation adaptor module 20 detects the current situation of the neural network device, and the output combination selector module 22 selects at least one class combination according to the situation detected by the situation detector module 21. In addition, the storage module 23 applies the structure and weight of the adaptive decision layer 33 corresponding to the selected class combination to the adaptive decision layer 33 so that the adaptive decision layer 33 is variable. In addition, the class corresponding to the input data can be identified according to the likelihood for each class output from the adaptive decision layer 33 for the applied input data. In this case, the likelihoods for each class output from a plurality of class combinations may be different, and when the likelihoods for each class according to each class combination are different, the situation detector module 21 may determine the class with the highest likelihood as the identified class.

For example, if the vector of the final FC layer FC_{L} in FIG. 2 is

$${Y}_{lastFClayer} = [ \begin{matrix}{y}_{lastFClayer}^{1} \\ ⋮ \\ {y}_{lastFClayer}^{N}\end{matrix} ] ,$$

and there are N1 classes in the selected class combination (group1), classification can be performed as follows. If Wᵢ^{group1}·Y_{lastFClayer}>Wₖ^{group1}·Y_{lastFClayer} for k=1, . . . , N₁ & j≠k, it can be classified into the j-th class.

In addition, if the input data includes objects for a plurality of classes, the class for each of a plurality of objects may be identified in a similar manner.

Here, the adaptive decision layer 33 may be referred to as a linear classifier, and is shown separately from the class classification unit 32 for convenience of understanding, however, the adaptive decision layer 33 can also be viewed as a component included in the class classification unit 32. As described above, class nodes Y₁ to Y_{N} can also be obtained as an output vector function of the adaptive decision layer 33 in FIG. 3.

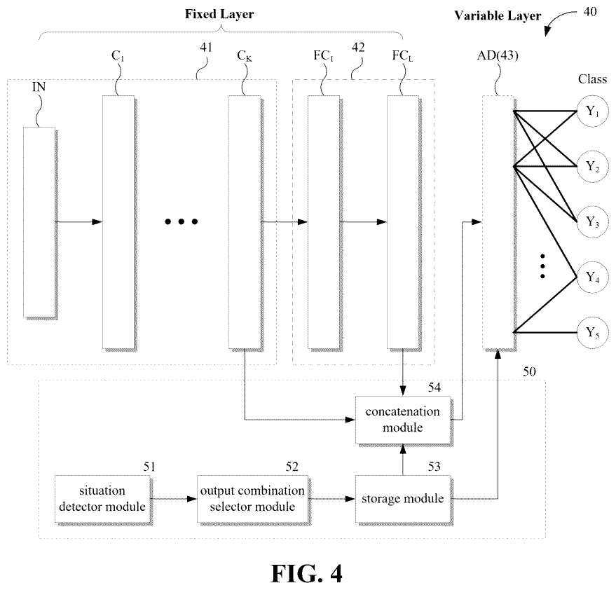

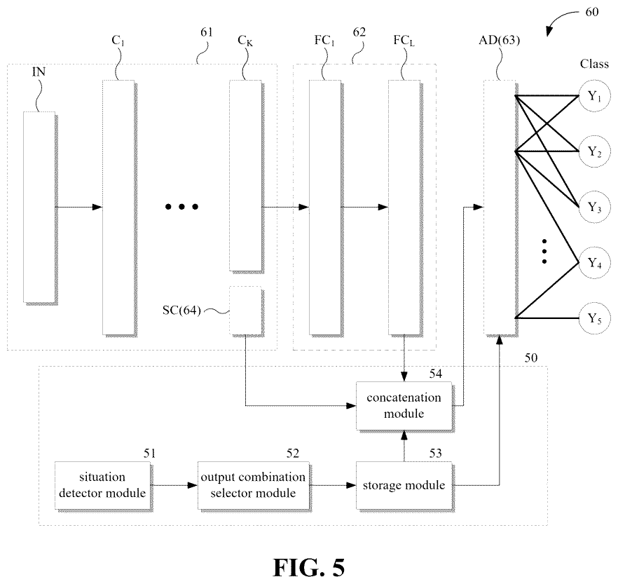

FIGS. 4 and 5 show schematic structures of a neural network device according to still other embodiments.

The neural network device in FIG. 4 also includes a neural network module 40 and a situation adaptor module 50. Like the neural network module 30 of FIG. 3, the neural network module 40 of FIG. 4 may include a feature extraction unit 41, a class classification unit 42, and an adaptive decision layer 43. Here, the layers of the feature extraction unit 41 and the class classification unit 42 are fixed layers in which the weights acquired through learning are fixed, as in FIG. 3, whereas the adaptive decision layer 43 is a variable layer whose structure and weight are varied according to the selected class combination and that outputs the likelihood for each class included in the class combination. However, unlike the adaptive decision layer 33 in FIG. 3, which receives only the linear sum of the output of the final FC layer FC_{L} as input, the adaptive decision layer 43 in FIG. 4 receives feature values output from one (here, the K-th feature extraction layer C_{K} as an example) of a plurality of feature extraction layers C₁ to C_{K} of the feature extraction unit 41 and outputs a likelihood for each class included in the class combination. This is to improve the accuracy of likelihood estimation by using the feature values obtained during the feature extraction process of the feature extraction unit 41 together when estimating the likelihood for each class, and a detailed description thereof will be described later.

Meanwhile, the situation adaptor module 50 may further include a situation detector module 51, an output combination selector module 52, a storage module 53, and a concatenation module 54. Since the situation detector module 51 and the output combination selector module 52 are the same as the situation detector module 21 and the output combination selector module 22 of FIG. 3, they will not be described in detail here. However, unlike the storage module 23 in FIG. 3, the storage module 53 further stores information about the feature extraction layer (here, the K-th feature extraction layer C_{K}) of the feature extraction unit 41 that will receive the feature values, as well as the structure and weights of the adaptive decision layer 43. That is, among the plurality of feature extraction layers C₁ to C_{K} of the feature extraction unit 41, information on the selection feature extraction layer to receive feature values is stored together during learning. In this case, when learning about individual class combinations, the feature extraction layer that will receive the feature value may performs learning while changing the feature extraction layer that transmits the feature values, and the feature extraction layer that shows the highest performance may be selected and stored as the selection feature extraction layer. For example, the feature extraction layer that causes the smallest loss when learning about individual class combinations may be selected as the selection feature extraction layer. The concatenation module 54 receives the output of the final FC layer FC_{L} and the output of the selection feature extraction layer, concatenates them, and inputs to the adaptive decision layer 43. In this way, the performance of the neural network device can be improved by receiving and concatenating the output of the final FC layer FC_{L} and the output of the selection feature extraction layer and inputting it to the adaptive decision layer 43.

However, in some cases, rather than concatenating the entire output of the selection feature extraction layer with the output of the final FC layer FC_{L} and inputting it to the adaptive decision layer 43, concatenating only a portion of the output of the selection feature extraction layer with the output of the final FC layer FC_{L} and inputting it to the adaptive decision layer 43 may result in better performance.

As a simple example, assume that a neural network device is a device that identifies numeric images from 0 to 9, and that you want to select and identify 3 and 5 or 8 and 9 as a class combination depending on the situation. In this case, if the neural network device selects 3 and 5 as the class combination, the differences appear concentrated at the top rather than the bottom of the image for 3 and 5, so rather than concatenating the entire output of the selection feature extraction layer with the output of the final FC layer FC_{L}, concatenating the output of the top area where the difference is concentrated with the output of the final FC layer FC_{L}, and inputting it to the adaptive decision layer 43 may obtain better results. On the other hand, if 8 and 9 are selected as a class combination, better results may be obtained by concatenating the output of the bottom area with the output of the final FC layer FC_{L} and inputting it to the adaptive decision layer 43.

Accordingly, in the neural network device of FIG. 4, the storage module 53 may additionally store information about the selection area as well as information about the selection feature extraction layer. In this case, the concatenation module 54 may concatenate the output from the selection area of the selection feature output layer and the output of the final FC layer FC_{L} and input it to the adaptive decision layer 43.

In FIG. 4, one of the feature extraction layers C₁ to C_{K} that has already been learned and has fixed weights and transmits the output to the next layer was selected as the selection feature extraction layer, and the output from all or part of the region was concatenated with the output of the FC layer FC_{L} and input to the adaptive decision layer 43.

However, FIG. 5 shows a case where the feature extraction unit 61 of the neural network module 60 further includes a separate sub-feature extraction layer SC (64) that extracts feature values to be concatenated with the output of the FC layer FC_{L}. Here, the sub-feature extraction layer 64 is a layer used when extracting feature values according to each class combination, and may be placed at a position corresponding to one feature extraction layer (here, as an example, the K-th feature extraction layer C_{K}) among the plurality of feature extraction layers C₁ to C_{K}. The sub-feature extraction layer 64 receives the output of the previous feature extraction layer C_{K-1} in the same way as the corresponding feature extraction layer C_{K} and performs a neural network operation. However, unlike the corresponding feature extraction layer C_{K}, the sub-feature extraction layer 64 is not connected to transmit output to the next layer (here, the first FC layer FC₁). This is because the sub-feature extraction layer 64 is only used when extracting feature values according to the corresponding class combination.

In addition, in FIG. 5, the concatenation module 54 concatenates the output of the sub-feature extraction layer 64 and the output of the FC layer FC₁ and inputs it to the adaptive decision layer 63 to identify the class.

This sub-feature extraction layer 64 is not provided when learning to identify all possible classes, but is provided only when learning according to class combinations to extract feature values, and when the extracted feature values are concatenated with the output of the FC layer FC_{L} and input to the adaptive decision layer 63, the resulting loss is back-propagated and learned. That is, the sub-feature extraction layer 64 is learned and the weight is updated only when learning the corresponding class combination. In addition, the weights obtained through learning according to each class combination are stored in the storage module 53.

Other than that, the remaining configuration and operation of the situation adaptor module 50 are the same as in FIG. 4 and will not be described here.

In FIG. 5, unlike in FIG. 4, an already learned feature extraction layer is not used, but a sub-feature extraction layer 64 that varies to have different weights depending on the class combination is further provided, so that the features of each class according to each class combination can be highlighted very well. Therefore, identification performance for classes of the corresponding class combination can be further improved. Even in this case, the placement position of the sub-feature extraction layer 64 and the weight of the adaptive decision layer 63 according to each class combination may be changed in various ways and stored in advance in the storage module 53.

In the illustrated embodiment, respective configurations may have different functions and capabilities in addition to those described below, and may include additional configurations in addition to those described below. In addition, in an embodiment, each configuration may be implemented using one or more physically separated devices, or may be implemented by one or more processors or a combination of one or more processors and software, and may not be clearly distinguished in specific operations unlike the illustrated example.

In addition, the neural network device shown in FIGS. 2 to 5 may be implemented in a logic circuit by hardware, firmware, software, or a combination thereof, and may be implemented using a universal or special purpose computer. The apparatus may be implemented using a hardwired device, a field programmable gate array (FPGA), an application specific integrated circuit (ASIC), or the like. In addition, the apparatus may be implemented as a System on Chip (SoC) including one or more processors and controllers.

In addition, the neural network device may be mounted in a computing device or server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

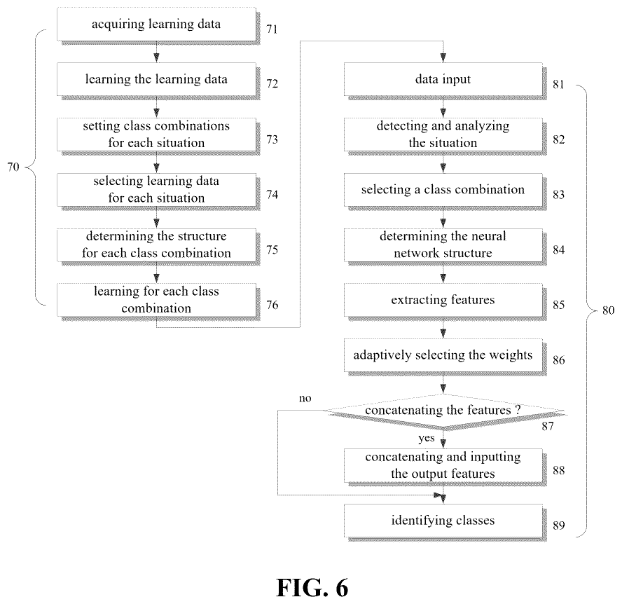

FIG. 6 shows an output handling method of a neural network device according to an embodiment.

Referring to FIGS. 2 to 5, the output handling method of a neural network device of FIG. 6 is described as follows. First, in the learning step (70), learning data for all classes that the neural network device is required to identify is acquired (71). Then, learning is performed according to the acquired learning data to obtain weights of a plurality of layers IN, C₁ to C_{K}, FC₁ to FC_{L} of the neural network module (72). Afterwards, class combinations for each of the various pre-anticipated situations are set (73). Here, each situation and the class combination for each situation may be set and stored in advance. Once the class combination for each situation is set, learning data for each class combination set according to each situation is selected (74). At this time, learning data containing classes included in the class combination is selected then, the structure of the neural network module according to the class combination is determined (75). At this time, the structure of the neural network module to be determined may include whether to add the adaptive decision layer 63 and whether to add the sub-feature extraction layer 64. In addition, if it is determined that the sub-feature extraction layer 64 is not added, it may be determined whether to extract all or part of the output of at least one feature extraction layer among the plurality of feature extraction layers C₁ to C_{K}.

Afterwards, learning is performed for each class combination based on learning data selected according to the situational class combination (76). At this time, if it is decided to add the adaptive decision layer 63, the weight of the adaptive decision layer 63 is obtained and stored, whereas if it is decided not to add the adaptive decision layer 63, the weight of the final FC layer FC_{L} is obtained and stored.

In addition, if it is determined that the sub-feature extraction layer 64 will be added, the location where the sub-feature extraction layer 64 will be placed and the weight are obtained and stored.

In addition, if it is decided to extract all or part of the output of at least one feature extraction layer among the a plurality of feature extraction layers C₁ to C_{K}, information about the selection feature extraction layer from which the output is extracted and the location where the output is to be extracted from the selection feature extraction layer is acquired and stored.

Afterwards, when learning for each class combination for each of the plurality of situations is completed, the learning step (70) is completed and the testing step (80) is performed.

In the testing step, test data is first input (81). The situation of the neural network device is detected and analyzed (82). At this time, the situation may be an external situation to the neural network device, but it may also be an internal situation depending on the likelihood of the previously selected class combination. In addition, it may also be a situation depending on the input test data. Then, a class combination is selected according to the detected and analyzed situation (83). At this time, at least one class combination may be selected, and the number and type of classes included in each class combination may be adjusted in various ways.

Afterwards, the structure of the neural network module is determined according to the selected class combination (84). Here, the structure of the neural network module to be determined follows the structure set for each class combination when learning each class combination, and as described above, it may include whether and where the adaptive decision layer 63 and the sub-feature extraction layer 64 are added, and whether to extract all or part of the output of at least one feature extraction layer.

Once the structure of the neural network module is determined, features are extracted by performing a neural network operation on the input test data based on the determined structure of the neural network module (85).

Then, the weights of the final FC layer FC_{L} or the adaptive decision layer 63 are adaptively selected according to the selected class combination and the determined neural network structure (86). In addition, it is determined whether to concatenate the features output from the selection feature extraction layer or sub-feature extraction layer 64 according to the determined neural network structure with the output of the layer before the final layer in the currently determined neural network module structure (87). If it is determined to concatenate, all or part of the features output from the selection feature extraction layer or sub-feature extraction layer 64 and the output of the layer before the final layer are concatenated and applied as input of the final layer (88).

Then, classes are identified in the test data inputted according to the likelihood of each class for the class combination output from the final layer (89).

In FIG. 6, it is described that respective processes are sequentially executed, which is, however, illustrative, and those skilled in the art may apply various modifications and changes by changing the order illustrated in FIG. 5 or performing one or more processes in parallel or adding another process without departing from the essential gist of the exemplary embodiment of the present disclosure.

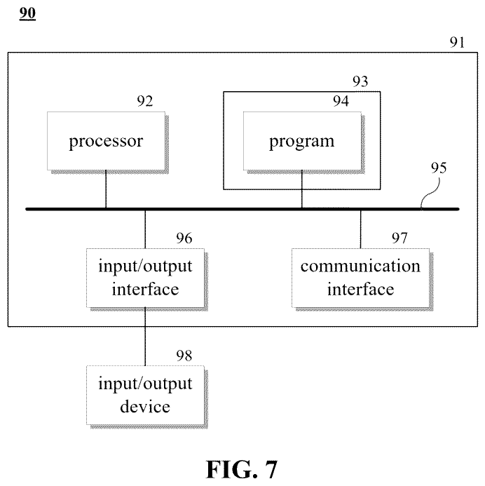

FIG. 7 is a diagram for explaining a computing environment including a computing device according to an embodiment.

In the illustrated embodiment, respective configurations may have different functions and capabilities in addition to those described below, and may include additional configurations in addition to those described below. The illustrated computing environment 90 may include a computing device 91 to perform the output handling method of a neural network device illustrated in FIG. 6. In an embodiment, the computing device 91 may be one or more components included in the neural network device shown in FIGS. 2 to 5.

The computing device 91 includes at least one processor 92, a computer readable storage medium 93 and a communication bus 95. The processor 92 may cause the computing device 91 to operate according to the above-mentioned exemplary embodiment. For example, the processor 92 may execute one or more programs 94 stored in the computer readable storage medium 93. The one or more programs 94 may include one or more computer executable instructions, and the computer executable instructions may be configured, when executed by the processor 92, to cause the computing device 91 to perform operations in accordance with the exemplary embodiment.

The communication bus 95 interconnects various other components of the computing device 91, including the processor 92 and the computer readable storage medium 93.

The computing device 91 may also include one or more input/output interfaces 96 and one or more communication interfaces 97 that provide interfaces for one or more input/output devices 98. The input/output interfaces 96 and the communication interfaces 97 are connected to the communication bus 95. The input/output devices 98 may be connected to other components of the computing device 91 through the input/output interface 96. Exemplary input/output devices 98 may include input devices such as a pointing device (such as a mouse or trackpad), keyboard, touch input device (such as a touchpad or touchscreen), voice or sound input device, sensor devices of various types and/or photography devices, and/or output devices such as a display device, printer, speaker and/or network card. The exemplary input/output device 98 is one component constituting the computing device 91, may be included inside the computing device 91, or may be connected to the computing device 91 as a separate device distinct from the computing device 91.

The present invention has been described in detail through a representative embodiment, but those of ordinary skill in the art to which the art pertains will appreciate that various modifications and other equivalent embodiments are possible. Therefore, the true technical protection scope of the present invention should be defined by the technical spirit set forth in the appended scope of claims.

What is claimed is:

1. A neural network device comprising: one or more processors; and a memory storing one or more program executed by the one or more processors,
wherein the processors
select at least one class combination of different numbers and types from N (where N is a natural number) classes designated for input data,
set, according to each class combination selected in a neural network module including a plurality of layers, at least one layer among the layers of the neural network module as a changeable variable layer, and
output a result of performing a neural network operation on the input data by changing the variable layer set according to the selected class combination, and a weight of the variable layer.

2. The neural network device according to claim 1,
wherein the processors
pre-designate and store variable layers whose weights is to be changed according to each class combination, and the weights, and
change the weights of the designated variable layers to the stored weights according to the selected class combination.
